(19) United States
(12) Patent Application Publication
(10) Pub. No.: US 2026/0196750 A1
(43) Pub. Date: Jul. 9, 2026

(54) CONDUCTOR TERMINAL AND PLUGGABLE CONNECTOR

(71) Applicant: WAGO Verwaltungsgesellschaft mbH, Minden (DE)

(72) Inventors: Finn Paul WELLING, Spenge (DE); Joel PALTEN, Bad Oeynhausen (DE)

(73) Assignee: WAGO Verwaltungsgesellschaft mbH, Minden (DE)

(21) Appl. No.: 19/442,621

(22) Filed: Jan. 7, 2026

(30) Foreign Application Priority Data
Jan. 9, 2025 (DE) 20 2025 100 084.9

(51) Int. Cl. H01R 11/09; H01R 4/48

(52) U.S. Cl. CPC H01R 11/09; H01R 4/4821; H01R 4/483; H01R 4/4833; H01R 4/4835; H01R 4/485

(57) ABSTRACT

A conductor terminal having one housing and several spring-loaded clamp connections, each of which has at least one clamping spring for clamping an electrical conductor by spring-loaded force. The conductor terminal for several or all of these spring-loaded clamp terminals each has an individual actuating element assigned to the spring-loaded clamp connection, by the actuation of which the clamping spring of the assigned spring-loaded clamp connection can be individually actuated to an open position. An electrical plug connector, in particular a circular connector, having at least one such conductor terminal, is also provided.

This nonprovisional application claims priority under 35 U.S.C. § 119(a) to German Patent Application No. 20 2025 100 084.9, which was filed in Germany on Jan. 9, 2025, and which is herein incorporated by reference.

### BACKGROUND OF THE INVENTION

### Field of the Invention

The invention relates to a conductor terminal having one housing and a plurality of spring-loaded clamp connections, each of which has at least one clamping spring for clamping an electrical conductor by spring-loaded force, wherein the conductor terminal has an individual actuating element assigned to each of several or all of these spring-loaded clamp connections, which actuating element can be actuated to individually move the clamping spring of the assigned spring-loaded clamp connection to an open position. The invention also relates to an electrical plug connector, in particular a circular connector, having at least one such conductor terminal.

### Description of the Background Art

A generic conductor terminal is known from DE 10 2021 112 960 A1, which corresponds to US 2024/0088578, which is incorporated herein by reference.

### SUMMARY OF THE INVENTION

It is therefore an object of the present invention is to provide an improved conductor terminal.

In the case of a conductor terminal of the type mentioned above, this object is achieved in that the conductor terminal has at least one general actuating element, via which the clamping springs of several or all of these spring-loaded clamp connections can be jointly actuated together to the open position. The invention allows for the user of such a conductor terminal to actuate individual clamping springs or only one clamping spring to the open position, depending on requirements and situation, either by actuating the respective individual actuating element or alternatively by actuating the general actuating element, to actuate the clamping springs of all spring-loaded clamp connections that can be actuated via the general actuating element together to the open position. Actuating several or all spring-loaded clamp connections together via the general actuating element is helpful, for example, when wiring the conductor terminal for the first time. However, if partial rewiring is required on an already wired conductor terminal, it is often not desirable to actuate all clamping springs to the open position, but only those clamping springs that are to be rewired. For this purpose, individual actuating elements can then be actuated by the user in a targeted manner. The general actuating element allows for the clamping springs, for example, to be actuated directly to the open position.

As mentioned, the several or all clamping springs can be actuated together to the open position via the general actuating element. For this purpose, the general actuating element may have a manual actuating surface, which is operated by applying manual force. By manually actuating this single manual actuating surface, the several or all clamping springs can then be moved together to the open position. The general actuating element can be moved, either entirely or at least predominantly, from an initial position to an actuated position by manually actuating this single manual actuating sur-face, for example, by a sliding movement and/or a rotational movement, in which the several or all clamping springs are moved to the open position. Thus, the general actuating element allows for several or all spring-loaded clamp connections to be actuated together and synchronously to the open position by actuating a single manual actuating surface.

Advantageously, the individual actuating elements can be actuated manually directly by the user without the need for an additional tool. It is also conceivable that the individual actuating elements are designed in such a way that in addition to the manual actuation, actuation can be done with a tool or can be done exclusively with a tool. The individual actuating elements can, in particular, be actuated at a point on the outside of the conductor terminal housing at a respective manual actuation point. Advantageously, the general actuating element can be actuated directly by the user manually without an additional tool. The housing of the conductor terminal can be designed as an insulating material housing.

Furthermore, in the case of the conductor terminal according to the invention, it is advantageously possible to actuate several or all clamping springs together to the open position via the general actuating element and then, after connecting the electrical conductors to the spring-loaded clamp connections, by actuating the respective individual actuating element in order to transfer a respective individual clamping spring to the clamping position in which an electrical conductor is clamped to the spring-loaded clamp connection.

According to an example of the invention, it is provided that at least one actuating contour for direct or indirect actuation of the respective clamping spring is arranged on a radial outer surface and/or on a radial inner surface of the general actuating element. Such an actuating contour allows for a clamping spring to be actuated directly, i.e., subjected to an actuating force, by the actuating contour applying a compressive force or tensile force directly to a clamping leg of the clamping spring. It is also conceivable that the actuating contour only indirectly actuates the clamping spring, e.g., by the presence of another mechanical element that transmits an actuating force of the actuating contour to the clamping spring. As explained below, the indirect actuation of the clamping spring can be carried out, for example, by actuating the individual actuating element assigned to the clamping spring. The actuating contour may be shaped accordingly for this purpose, e.g., as an actuating contour protruding from a radial outer surface and/or a radial inner surface or as an actuating contour recessed with respect to this radial outer surface and/or radial inner surface. To the extent that the term “radial” is used in connection with the general actuating element, this means that the general actuating element may have a cylindrical or ring-shaped body, or such a body may be polygonal on the outside or on an inside.

The general actuating element can be designed to actuate the respective clamping spring indirectly by actuating the individual actuating element assigned to this clamping spring to the open position. In this case, the individual actuating element can be subjected to an actuation force via an actuating contour of the general actuating element. This enables a variety of design variants for the conductor terminal, so that this can be optimally adapted for the respective application.

The general actuating element can have a main body from which several actuating arms extend in a radial direction, wherein the actuating arms are designed to transmit an actuating force from the general actuating element to an individual actuating element or a clamping spring. Such actuating arms allow for reliable transmission of an actuating force to the respective individual actuating element or the clamping spring, while at the same time providing a robust design of the general actuating element. For example, the actuating arms can protrude radially outwards or radially inwards from the main body, depending on the design of the main body.

One, several or all individual actuating elements can be designed as a swiveling actuating lever or as a sliding actuating push button or other sliding actuating element. In this way, the conductor terminal can be optimally adapted to the respective application with regard to the individual actuating elements, depending on whether lever actuation, handle actuation or slide actuation is more advantageous. A sliding actuating push button can be characterized in that it is slidably arranged in an actuating shaft of the housing and can be actuated by applying a compressive actuating force to an end face accessible on the outside of the housing. In contrast, a sliding actuating element, which can also perform a sliding movement like an actuating push button, can be actuated via a manual actuating section mounted on the outside of the housing and movable along the outside.

The spring-loaded clamp connections can be arranged in a ring shape in the housing of the conductor terminal. This enables a compact design of the conductor terminal, as a large number of spring-loaded clamp connections can be arranged in the ring shape to save space. The spring-loaded clamp connections arranged in the ring shape can, for example, surround a housing center of the conductor terminal in a ring-like manner. For example, the spring-loaded clamp connections can be arranged on a circular path in the housing. The spring-loaded clamp connections can be evenly distributed on the circular path. In principle, the housing can have any outer contour. Advantageously, the design of the housing is a round housing, e.g., with a cylindrical shape, the longitudinal direction of which coincides with a displacement direction of the general actuating element.

The general actuating element can be positioned in a central area of the conductor terminal which is within the area bounded by the ring shape of the spring-loaded clamp connections. In this way, the general actuating element can be actuated in a simple and ergonomically advantageous manner at a central point in the housing. In such a design, it is advantageous, for example, to design the general actuating element as a sliding actuating element or actuating push button that can be actuated in one direction of displacement. This allows for good structural integration of such a general actuating element into the conductor terminal.

The general actuating element can have a ring-shaped main body which encircles the area bounded by the ring shape of the spring-loaded clamp connections in a ring-like manner. In this case, the general actuating element can be designed either as a sliding push button or as an actuating element that can be rotated about the longitudinal axis of the conductor terminal. Such a ring-shaped main body can be used to achieve a relatively large diameter, through which actuating forces can be transmitted well, especially during rotary actuation.

The general actuating element can be configured to be manually actuated on its ring-shaped main body on one circumferential side of a cylindrical housing of the conductor terminal. This makes it possible, for example, to arrange the ring-shaped main body not only on one end face of the housing, but also away from the end face.

The individual actuating elements can be configured to be actuated outside the area bounded by the ring shape of the spring-loaded clamp connections. Accordingly, at least manual actuating sections of the individual actuating elements are arranged outside the area bounded by the ring shape. Each of the individual actuating elements may also be arranged wholly or at least predominantly outside the area bounded by the ring shape of the spring-loaded clamp connections. In this variant, the individual actuating elements can be advantageously designed as swiveling actuating levers or sliding actuating elements.

The individual actuating elements can be configured to be actuated within the area bounded by the ring shape of the spring-loaded clamp connections. In this variant, the individual actuating elements can be designed particularly advantageously as sliding actuating push buttons. Each of the individual actuating elements can be arranged completely or at least predominantly within the area bounded by the ring shape of the spring-loaded clamp connections.

The general actuating element can be configured as a linearly sliding actuating push button or as a swiveling or rotatable actuating element that can be rotated about an axis of rotation. This enables simple and ergonomic operation of the general actuating element.

The direction of displacement or the axis of rotation of the general actuating element can run orthogonally to a plane defined by the ring shape of the spring-loaded clamp connections. In this case, the direction of displacement or the axis of rotation can be parallel to a longitudinal axis of the housing. If the conductor terminal is designed as an electrical plug connector, the displacement direction or the axis of rotation can be parallel to the connector's mating direction, in which the connector can be mated with a mating connector.

The conductor terminal can have a spring return element by which the general actuating element is spring-loaded in the direction of its unactuated position. This has the advantage that the general actuating element is reliably relocated to the unactuated position by the spring return element if it is not subjected to an actuating force. A return force generated by the clamping springs is then not absolutely necessary.

The clamping springs actuated to the open position via the general actuating element can be fixed in the open position, even if the general actuating element is no longer actuated or has been moved to its unactuated position. This has the advantage that the user only has to briefly press the general actuating element once but does not have to hold it in place to connect the individual electrical conductors. The clamping springs fixed in the open position allow for the electrical conductors to be inserted and connected without any effort. Each clamping spring can be held in the open position, for example, by a respective retaining element. The clamping spring can be held in the open position in particular by the individual actuating element assigned to the clamping spring, e.g., in that the individual actuating element in the open position is in an over-center position, e.g., if the individual actuating element is designed as a swiveling lever. To shift the clamping spring to the clamping position, the respective individual actuating element must then be manually moved in the direction of its unactuated position.

The object mentioned above is also achieved by an electrical plug connector, in particular a circular connector, which has at least one conductor terminal of the type explained above. This also allows for the advantages explained above to be realized.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a conductor terminal in perspective view,

FIG. 2 is a general actuating element of the conductor terminal in accordance with FIG. 1,

FIG. 3 is an individual actuating element of the conductor terminal in accordance with FIG. 1,

FIG. 4 is the conductor terminal according to FIG. 1 in lateral sectional view,

FIG. 5 is the interaction of the general actuating element and an individual actuating element with a spring-loaded clamp connection in the unactuated state, and

FIG. 6 is the arrangement according to FIG. 5 in the actuated state.

### DETAILED DESCRIPTION

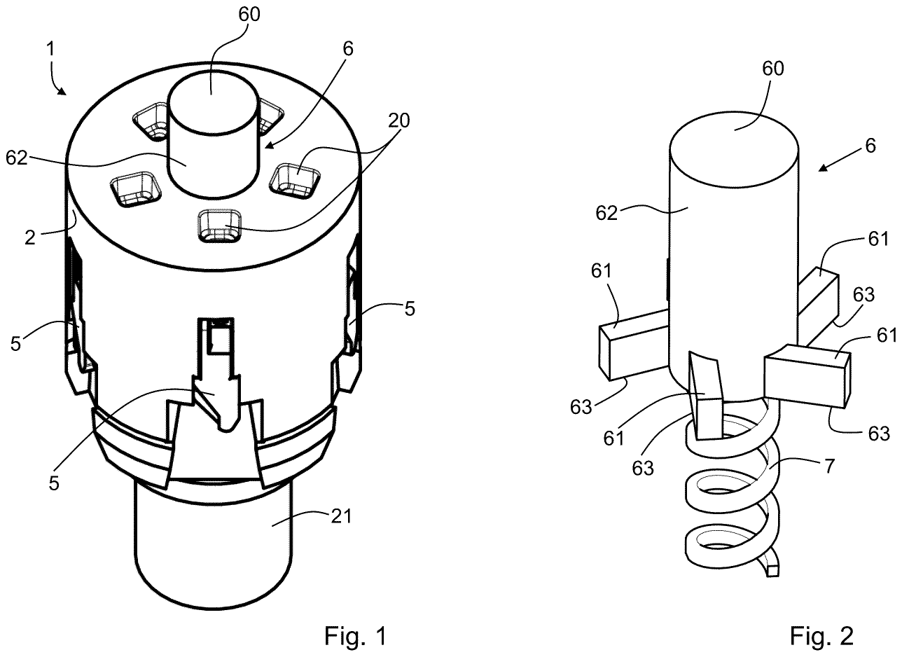

FIG. 1 shows a conductor terminal 1 with a housing 2 in which several spring-loaded clamp connections are arranged. The housing 2 has a conductor entry opening 20 for each spring-loaded clamp connection, through which an electrical conductor can be inserted into the housing 2 and clamped to the spring-loaded clamp connection. As can be seen, the housing 2 has a round shape, especially a cylindrical shape. The conductor entry openings 20 are arranged at one end face of the cylindrical shape and surround a center of the housing 2 in the manner of a ring.

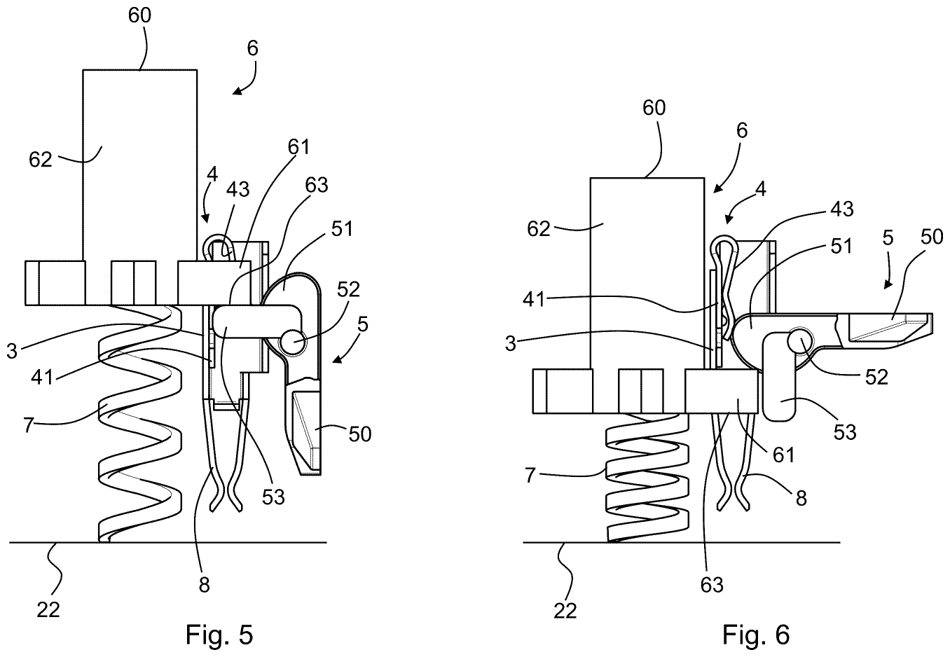

The housing 2 has a plug section 21 on the side facing away from the conductor entry openings 20, through which the conductor terminal 1 is designed as an electrical plug connector, in particular as a circular connector. Several electrical plug contacts 8 may be arranged in the plug section 21, e.g., one plug-in contact each assigned to a spring-loaded clamp connection, as can be seen by way of example in FIGS. 5 and 6.

To actuate a respective clamping spring of a spring-loaded clamp connection, the conductor terminal 1 has an individual actuating element 5 assigned to the spring-loaded clamp connection, e.g., in the form of a swiveling actuating lever. The respective individual actuating element 5 is accessible on a circumferential side of the housing 2 for manual actuation.

The conductor terminal 1 also has a general actuating element 6, which is used for the joint and, in particular, synchronous actuation of all spring-loaded clamp connections of the conductor terminal 1. The general actuating element 6 has a main body 62, which is arranged in a central position in the housing 2 and is located in particular within the ring shape formed by the conductor entry openings 20. The main body 62 protrudes from the housing 2, at least in the unactuated state of the general actuating element 6, at the end face of the housing 2 where the conductor entry openings 20 are located. A manual actuating surface 60 is formed on the main body 62, on which the general actuating element 6 can be actuated by application of manual compressive force, and thereby the main body 62 can be moved further into the housing 2.

FIG. 2 shows the general actuating element 6 as a single component, together with a spring return element 7. As can be seen, the main body 62, for example, can be essentially cylindrical, but other shapes are also conceivable, e.g., a polygonal cross-sectional shape. On the main body 62 several actuating arms 61 are arranged, which extend in a radial direction from the main body 62. On each actuating arm 61 there is an actuating contour 63 for direct or indirect actuation of the respective clamping spring. For example, on the main body 62 for each spring-loaded clamp connection, an actuating arm 61 may be assigned to the spring-loaded clamp connection.

On the side of the main body 62 facing away from the manual actuating surface 60, the spring return element 7 is arranged, e.g., a spiral-shaped compression spring. The spring return element 7 can be made of metal or plastic. For example, the general actuating element 6 may be designed as a plastic component in which the actuating arms 61 are integrally formed on the main body 62. In addition, the spring return element 7 can be formed integrally with the main body 62.

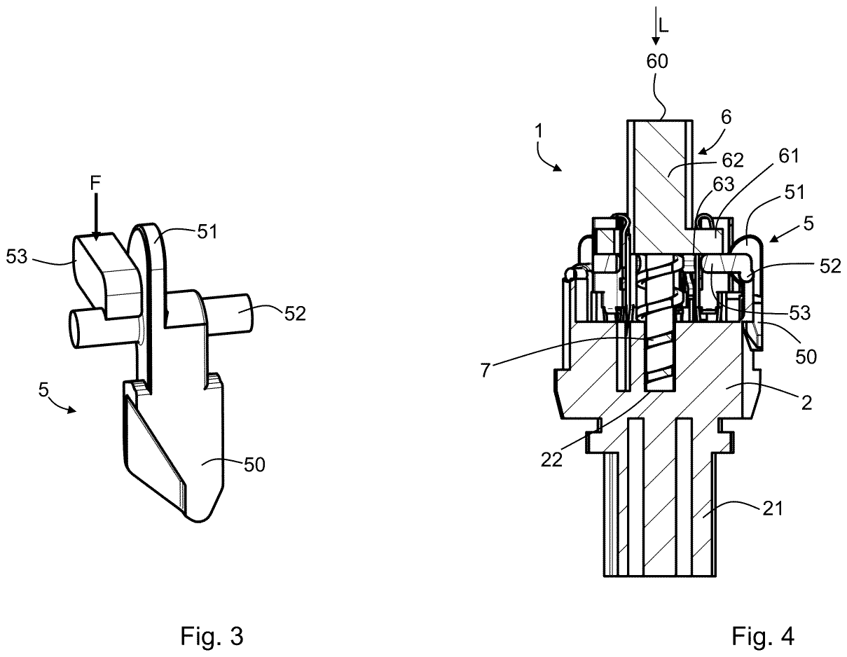

FIG. 3 shows an individual actuating element 5 as a single component. As mentioned, the individual actuating element 5 is designed as a swiveling actuating lever that can be swiveled about an axis of rotation 52. For example, the axis of rotation 52 can be formed by cylindrical bearing pins, as shown. Via the axis of rotation 52, the individual actuating element 5 is rotatable in the housing 2. The individual actuating element 5 has a manual actuating section 50 to which an actuating force can be applied by the user to swivel the individual actuating element 5. The individual actuating element 5 also has a spring loading section 51, which can be used to deflect to the open position via the individual actuating element 5 when the clamping legs of a clamping spring are swiveled. Furthermore, the individual actuating element 5 has a control section 53 via which the individual actuating element 5 inside the housing 2 can be subjected to an actuating force F, in particular via an actuating arm 61 of the general actuating element 6.

FIG. 4 shows the installation situation of the general actuating element 6 and an individual actuating element 5 in the conductor terminal 1 with the housing 2 partially open. FIG. 4 shows the unactuated state in which the spring-loaded clamp connection is in the clamping position and neither the general actuating element 6 nor an individual actuating element 5 are manually actuated. In this state, the control section 53 protrudes radially inwards and overlaps in the longitudinal direction L of the conductor terminal 1 with an actuating arm 61. If a compressive force is applied to the general actuating element 6 on the manual actuating surface 60, a corresponding actuating force F may be transmitted via the actuating contour 63 of an actuating arm 61 to the control section 53 of an individual actuating element 5 and the individual actuating element 5 may be swiveled about the axis of rotation 52 in this way without actuating the manual actuating section 50 of the individual actuating element 5. This is explained further below using FIGS. 5 and 6.

FIG. 5 shows the components already evident in FIG. 4: general actuating element 6, individual actuating element 5 and spring return element 7 without the housing 2 and without the other spring-loaded clamp connections, i.e., for the sake of clarity, only one spring-loaded clamp connection is shown. The spring-loaded clamp connection has a clamping spring 4 and a busbar 3. The clamping spring 4 has a contact leg 41 and a clamping leg 43. The clamping leg 43 can be connected to the contact leg 41 via a spring arc. The busbar 3 may, for example, have a U-shaped or rectangular profile, wherein the clamping spring 4 rests with the contact leg 41 on one side of this profile, e.g., on a contact section of the busbar, and can clamp an electrical conductor on an opposite side of the profile, e.g., on a contact section of the busbar, with the clamping leg 43. FIG. 5 shows the arrangement, like FIG. 4, again in an unactuated state.

The clamping leg 43, together with the contact portion of the busbar 3, can form a clamping point for clamping an electrical conductor between the clamping leg 43 and the contact section. In the open position, at least the free end of the clamping leg 43 is swiveled away from the contact section of the busbar 3. The clamping leg 43 can be swiveled, for example, between an open position, in which the electrical conductor is freely movable between the clamping leg 43 and the contact section, and a clamping position, in which the clamping leg 43 clamps the electrical conductor to the contact section.

It can also be seen that an electrical plug contact 8 can be connected to the busbar 3. In the assembled state of the conductor terminal 1, the electrical plug contact 8 is located in the plug section 21. Due to the spring return element 7, the general actuating element 6 is spring-loaded in the direction of its unactuated position.

FIG. 6 shows the arrangement according to FIG. 5 in the actuated state. In this process, the general actuating element 6 was shifted downwards by a compressive force on the manual actuating surface 60, i.e., in the direction of the support contour 22, so that the spring return element 7 was compressed. An actuating force was transmitted to the control section 53 of the individual actuating element 5 via the actuating contour 63, whereby it was swiveled by a certain angle, e.g., essentially 90 degrees. By swiveling the individual actuating element 5, the clamping leg 43 has been deflected via the spring loading section 51, i.e., it has been shifted from a clamping position given in FIG. 5 to an open position in which an electrical conductor can be inserted without effort and can be clamped to the busbar 3 by the clamping leg 43 after being transferred to the clamping position.

FIG. 6 shows that the spring-loaded clamp connection and the individual actuating element 5 are coordinated in such a way that the spring force of the clamping leg 43, which acts on the spring loading section 51, does not allow for the individual actuating element 5 to be automatically reset by this spring force, because the individual actuating element 5 is in an over-center position, in which the open position of the clamping leg is automatically held via the individual actuating element 5. The user therefore does not have to maintain this open position by continuously operating the general actuating element 6. When the operation of the general actuating element 6 is stopped, the spring return element 7 causes the general actuating element 6 to be returned to the unactuated position, as shown in FIG. 5. In this case, the individual actuating element 5 remains in the actuated position according to FIG. 6 until the individual actuating element 5 is swiveled in the direction of its unactuated position by applying force to the manual actuating section 50.

As can be seen, with the conductor terminal 1, it is also possible to move a clamping leg 43 to the open position without actuating the general actuating element 6, simply by actuating the respective assigned individual actuating element 5 at its manual actuating section 50. In this case, too, the open position can be maintained by the over-center position of the individual actuating element 5.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A conductor terminal comprising:
a housing;
at least two spring-loaded clamp connections, each of which having at least one clamping spring to clamp an electrical conductor by spring-loaded force;
an individual actuating element assigned to each of the at least two spring-loaded clamp connections, by the actuation of which the clamping spring of the assigned spring-loaded clamp connection is individually actuated to an open position; and
at least one general actuating element via which the clamping springs of several or all of these spring-loaded clamp connections are adapted to be actuated together to the open position.

2. The conductor terminal according to claim 1, wherein at least one actuating contour for direct or indirect actuation of the respective clamping spring is arranged on a radial outer surface and/or on a radial inner surface of the general actuating element.

3. The conductor terminal according to claim 1, wherein the general actuating element is configured to actuate the respective clamping spring indirectly to the open position by actuating the individual actuating element assigned to this clamping spring.

4. The conductor terminal according to claim 1, wherein the general actuating element has a main body from which several actuating arms extend in a radial direction, and wherein the actuating arms are configured to transmit an actuating force from the general actuating element to a respective individual actuating element or a clamping spring.

5. The conductor terminal according to claim 1, wherein one, several or all individual actuating elements are designed as swiveling actuating levers or as sliding actuating push buttons or other sliding actuating elements.

6. The conductor terminal according to claim 1, wherein the spring-loaded clamp connections are arranged in a ring shape in the housing of the conductor terminal,

7. The conductor terminal according to claim 6, wherein the general actuating element is arranged in a central area of the conductor terminal, which is within the area bounded by the ring shape of the spring-loaded clamp connections.

8. The conductor terminal according to claim 6, wherein the general actuating element has a ring-shaped main body which encircles the area bounded by the ring shape of the spring-loaded clamp connections in a ring-like manner.

9. The conductor terminal according to claim 8, wherein the general actuating element is designed to be manually actuated on its ring-shaped main body on a circumferential side of a cylindrical housing of the conductor terminal.

10. The conductor terminal according to claim 6, wherein the individual actuating elements are configured to be actuated outside the area bounded by the ring shape of the spring-loaded clamp connections.

11. The conductor terminal according to claim 6, wherein the individual actuating elements are configured to be actuated within the area bounded by the ring shape of the spring-loaded clamp connections.

12. The conductor terminal according to claim 1, wherein the general actuating element is designed as a linearly sliding actuating push button or as an actuating element which is swiveling or rotatable about an axis of rotation.

13. The conductor terminal according to claim 12, wherein the direction of displacement or the axis of rotation of the general actuating element runs orthogonally to a plane defined by the ring shape of the spring-loaded clamp connections.

14. The conductor terminal according to claim 1, wherein the conductor terminal has a spring return member by which the general actuating element is spring-loaded in the direction of its unactuated position.

15. The conductor terminal according to claim 1, wherein the clamping springs actuated to the open position via the general actuating element are fixed in the open position, even if the general actuating element is no longer actuated or has been moved to its unactuated position.

16. An electrical plug connector, in particular circular connector, comprising at least one conductor terminal according to claim 1.
